(19) United States
(12) Patent Application Publication
(10) Pub. No.: US 2022/0002530 A1
(43) Pub. Date: Jan. 6, 2022

(54) HIGH MELT STRENGTH STYRENE RESIN COMPOSITION AND PREPARATION METHOD THEREFOR

(71) Applicant: FINE-BLEND POLYMER (SHANGHAI) CO., LTD., Shanghai (CN)

(72) Inventors: Hao DUAN, Shanghai (CN); Congshan ZHU, Shanghai (CN); Junjie TANG, Shanghai (CN)

(21) Appl. No.: 17/288,900

(22) PCT Filed: Sep. 21, 2018
(86) PCT No.: PCT/CN2018/107135

§ 371 Date: Apr. 26, 2021

(30) Foreign Application Priority Data
Jan. 9, 2018 (CN) 201810019938.6

(51) Int. Cl. C08L 25/12; C08K 5/13; C08L 55/02; C08L 69/00; C08L 25/14; C08L 25/10; B29C 48/40; C08J 3/12

(52) U.S. Cl. CPC C08L 25/12; C08K 5/13; C08L 55/02; C08L 69/00; C08L 2205/02; C08L 25/10; B29C 48/40; C08J 3/12; C08L 2201/08; C08L 25/14

(57) ABSTRACT

Provided by the present invention is a high melt strength styrene resin composition. The composition includes the following components proportioned according to certain parts by weight: a styrene resin or a styrene alloy, a tackifier, an antioxidant and a lubricant. Compared to the existing technology, the present invention has the following beneficial effects: 1. a random copolymer used as the tackifier in the present invention is thermodynamically compatible with the styrene resin and the alloy thereof, does not experience phase separation, and has excellent mechanical properties; 2. the random copolymer used as the tackifier in the present invention has a moderate molecular weight, and is more easily plasticized than a rubber powder, a SAN powder having a high molecular weight, a heat-resistant powder, and so on, thus having better processability, uniform thickness, and low shrinkage rate, and not frequently experiencing the problem of surface defects.

### TECHNICAL FIELD

The invention relates to a high melt strength styrene resin composition and a preparation method therefor, and relates to polymer material area.

### BACKGROUND ART

ABS resin is an excellent resin with excellent impact resistance, heat resistance, dimensional stability and excellent dyeing properties. It has been widely used in electrical and electronic, home appliances, automotive and other fields, and is suitable for various applications, manufacturing processes. The most common processing method is an injection molding, in addition to extrusion and blow molding processes. For example, automotive tail fins and spoilers are usually prepared by a blow molding process, while refrigerator linings are generally prepared by a blister process. In the process of blow molding, if the melt strength of the material is insufficient, the phenomenon of collapse and collapse of the body is likely to occur; a series of problems, such as partial too thin or even cracking, occur during the blistering. Therefore, in addition to good mechanical properties, ABS resins used in such articles are required to have high melt strength and heat resistance.

Heat resistance can be improved by heat-resistant agents, but the improvement of melt strength is difficult. Modification manufacturers often add low-flow products, such as rubber powder, high-molecular-weight SAN powder, heat-resistant powder, and the like, to increase the melt strength of the material. However, these solutions cannot completely solve the above problems, and at the same time, they introduce other problems, such as poor plasticization, excessive shrinkage, and also easily cause problems of uneven wall thickness and surface defects.

The shortcomings of these technical solutions have greatly limited the wide application of ABS resin in the fields of extrusion, blow molding and plastic products.

Similar problems exist in HIPS, ASA, SAN and corresponding PC/ABS alloys, PC/ASA alloys. Therefore, the method of increasing the melt strength has become the focus of research. A preparation method for obtaining a higher melt strength of a styrene resin and an alloy thereof which is simple in process, excellent in physical and mechanical properties, and low in cost has not been reported yet.

### Technical Problem

The object of the invention of the present invention is to provide a high melt strength styrenic resin composition and a preparation method therefor.

### Technical Solution

The invention is achieved by the following technical solutions:

In one embodiment, the invention provides a high melt strength styrene resin composition, which includes the following components in parts by mass:

| | |
|---|---|
| Styrene resin or styrene alloy | 100 parts; |
| Tackifier | 5 to 30 parts; |
| Antioxidant | 0.1 to 0.5 parts; |
| Lubricant | 0.3 to 1.0 parts. |

Preferably, the tackifier is a random copolymer obtained by copolymerizing an aromatic vinyl monomer and an acrylonitrile monomer.

Preferably, an average molecular weight of the tackifier is from 200,000 to 400,000.

Preferably, the tackifier includes 50-85% of the aromatic vinyl monomer by mass and 10-40% of the acrylonitrile monomer by mass in.

Preferably, the tackifier includes a long-chain branched structure and the average molecular weight of the long-chain branch is from 10,000 to 90,000.

Preferably, the aromatic vinyl monomer is at least one selected from the group consisting of styrene, α-methylstyrene, α-chlorostyrene and p-methylstyrene; the acrylic monomer is one or two selected from the group consisting of acrylonitrile and α-methacrylonitrile.

Preferably, the styrene resin is at least one selected from the group consisting of ABS resin, SAN resin, ASA resin and HIPS resin; the styrene alloy is one or two selected from the group consisting of PC/ABS alloy and PC/ASA alloy.

Preferably, the antioxidant is a phenolic antioxidant.

In another embodiment, the invention provides a method for preparing the high melt strength styrene resin composition, and the method includes the following steps:

mixing a styrene resin or styrene alloy, a tackifier and a lubricant at 25 to 90° C., and

using a twin screw extruder abrasive machining to extrude pellets at 200 to 260° C. to obtain the high melt strength styrene resin composition.

Preferably, a ratio of length and diameter of the twin screw extruder abrasive machine is more than 34.

### Beneficial Effect

Compared with the prior art, the present invention has the following beneficial effects:

1. The random copolymer tackifier in the present invention is thermodynamically compatible with the styrene resin and the alloy thereof, does not cause phase separation, and has excellent mechanical properties;

2. The random copolymer tackifier in the present invention has a moderate molecular weight, is more easily plasticized than a rubber powder, a high molecular weight SAN powder, a heat resistant powder or the like, and thus has better processability, uniform thickness, and low shrinkage, and does not likely produce surface defects;

3. The random copolymer a tackifier of the present invention has a long-chain branch structure. When a polymer material has a long-chain branched molecular structure, the material will exhibit strain hardening, thereby causing a large strain locally in the material. No rupture occurs, and there is sufficient strength to deform the surrounding part and is uniformly thin as a whole;

4. Wide range of uses: suitable and effective for ABS, SAN, ASA, HIPS, PC/ABS alloy and PC/ASA alloy;

5. The process is simple, the cost is low, the production difficulty and the investment cost are reduced, and the products prepared by the method can be widely used in the fields of home appliances, automobiles, aviation and the like. It has a very broad application prospects and industrial value.

### DRAWINGS

Other features, objects and advantages of the present invention will become more apparent by reading the detailed description of the non-limiting embodiments with reference to the following drawings:

FIG. 1 shows the test results of tensile rheology of the samples obtained in Examples 1 to 3 and Control 1;

FIG. 2 shows the results of mechanical testing of the samples obtained in Examples 1 to 3 and Control 1;

FIG. 3 shows the results of tensile test at high temperature of the samples obtained in Examples 1 to 4 and controls 1 to 3.

### EMBODIMENTS OF THE INVENTION

The invention is described in detail below in combination with the specific embodiment. The following embodiments will help those skilled in the art to further understand the invention, but will not limit the invention in any form. It should be noted that for ordinary technicians in the art, a number of deformation and improvements can be made without departing from the concept of the invention. These are all under the protection scope of the present invention.

TABLE 1
Formulation table of the examples and the controls

| Materials | Example 1 | Example 2 | Example 3 | Example 4 | Example 5 | control 1 | control 2 | control 3 | control 4 |
|---|---|---|---|---|---|---|---|---|---|
| High rubber powder 180 | 50 | 50 | 50 | 50 | 30 | 50 | 50 | 50 | 30 |
| AS-128L | 50 | 50 | 50 | 50 | 40 | 50 | 50 | 50 | 50 |
| PC 1100 | | | | | 30 | | | | 30 |
| Tackifier | 10 | 20 | 30 | 20 | 10 | | 50 | 70 | |
| TAF | 0.3 | 0.3 | 0.3 | 0.3 | 0.3 | 0.3 | 0.3 | 0.3 | 0.3 |
| 1010 | 0.1 | 0.1 | 0.1 | | 0.2 | 0.1 | 0.1 | 0.1 | 0.2 |
| 168 | 0.2 | 0.2 | 0.2 | 0.2 | 0.2 | 0.2 | 0.2 | 0.2 | 0.2 |
| 245 | | | | 0.2 | | | | | |

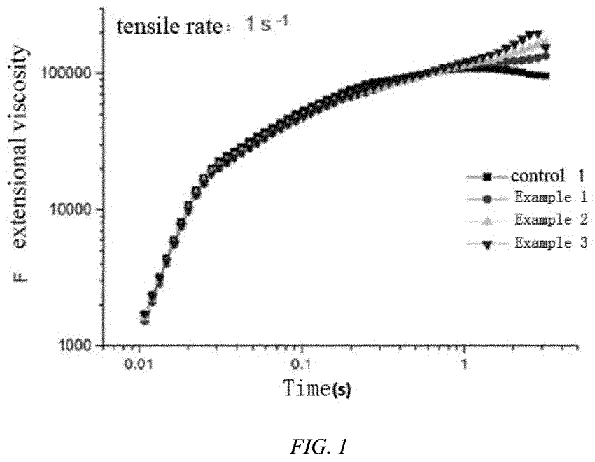

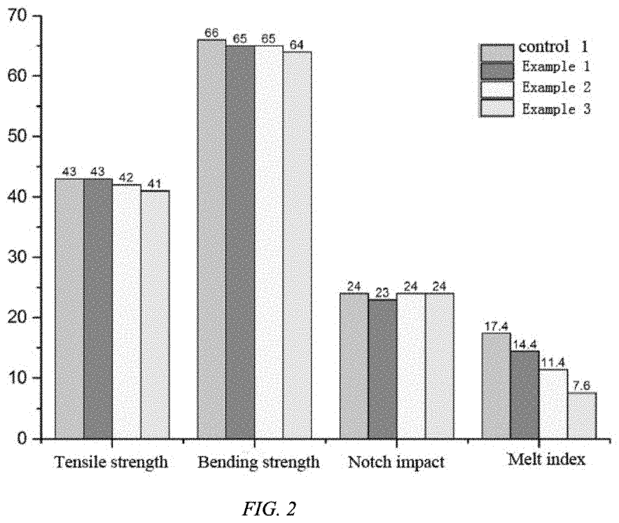

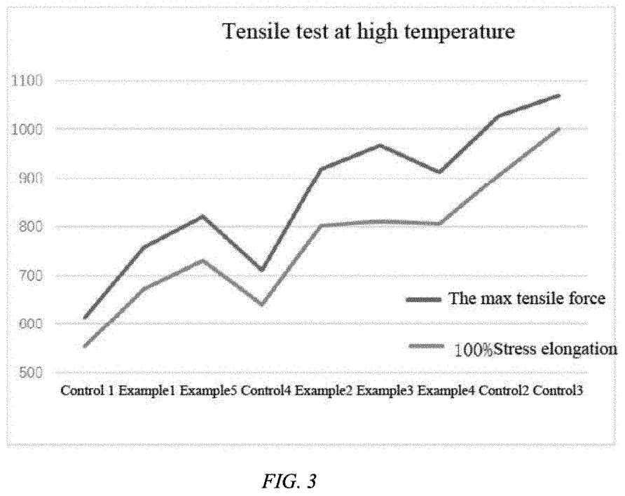

The formulated products above were extruded by the twin screw extruder abrasive machining and dried in the oven at 80° C. for 2 h. The tensile rheology of the particles was measured by a capillary rheometer, and the test results are shown by FIG. 1. At the same time, the particles were injected and molded into standard splines; mechanical properties (results shown by FIG. 2) and tensile strength at high temperature (results shown by FIG. 3) were measured; and the surface of the blow molded product was observed, the smoothness of the surface was expressed by the number 1-5 (results shown is Table 2), the higher number the better.

The test conditions were as follows:

IZOD notch impact: measured according to ASTM D256, the strip thickness being 3.2 mm;

Flexural modulus: measured according to ASTM D790 standard, test speed being 3 mm/min;

Tensile properties: measured according to ASTM D628 standard, tensile rate being 5 mm/min;

Melt Index: measured according to ASTM D1238, with test conditions of 220° C.*10 Kg;

Tensile strength at high temperature: measured according to DIN EN ISO 527-3.

As shown by FIG. 1, comparing Examples 1 to 3 and Control 1, the ABS in Control 1 did not show a phenomenon in which the viscosity rapidly increased after a certain time, and the product of Example 1 showed that there was a certain degree of uplifting and strain hardening characteristics were observed. Examples 2 and 3 also showed obvious upturning and significant strain hardening characteristics. Strain hardening indicates an increase in melt viscosity.

As shown in FIG. 2, there was no significant difference in basic mechanical properties between Control 1 and Examples 1 to 3. There was no side effect on the mechanical property but the melt strength of the styrene resin and styrene alloy was significantly improved.

As shown in FIG. 3, the high-temperature tensile properties and high-temperature tensile properties of Examples 1 to 5 and controls 1 to 4 can simulate the properties of the materials in the processes of blow molding and blistering to the greatest extent. As shown in the figure, the high-temperature tensile properties of Examples 1 to 3 relative to Control 1 and Example 5 relative to Control 4 significantly increased. The high-temperature tensile properties of controls 2 to 3 were also good. but from the data of Table 2, their liquidity is poor. In summary, Examples 1 to 3 have excellent mechanical properties, good processing properties, and high melt strength, and the process is simple and cost down.

TABLE 2
Fluidity and appearance of the examples and the controls

| Item | Example 1 | Example 2 | Example 3 | Example 4 | Example 5 | control 1 | control 2 | control 3 | control 4 |
|---|---|---|---|---|---|---|---|---|---|
| MI 220° C.*10 Kg | 14.4 | 11.4 | 7.6 | 11.4 | 12.8 | 17.4 | 3.4 | 1.9 | 16 |
| appearance | 5 | 5 | 4 | 5 | 4 | 5 | 3 | 1 | 4 |

The specific embodiments of the present invention have been described above. It is to be understood that the invention is not limited to the specific embodiments described above, and various modifications and changes may be made by those skilled in the art without departing from the scope of the invention.

1. A high melt strength styrene resin composition, comprising the following components in parts by mass:
a styrene resin or styrene alloy: 100 parts;
a tackifier: 5 to 30 parts;
an antioxidant: 0.1 to 0.5 parts;
a lubricant: 0.3 to 1.0 parts.

2. The high melt strength styrene resin composition according to claim 1, wherein the tackifier is a random copolymer obtained by copolymerizing an aromatic vinyl monomer and an acrylonitrile monomer.

3. The high melt strength styrene resin composition according to claim 2, wherein an average molecular weight of the tackifier is from 200,000 to 400,000.

4. The high melt strength styrene resin composition according to claim 2, wherein the tackifier includes 50-85% of the aromatic vinyl monomer by mass and 10-40% of the acrylonitrile monomer by mass.

5. The high melt strength styrene resin composition according to claim 2, wherein the tackifier includes a long-chain branch and an average molecular weight of the long-chain branch is from 10,000 to 90,000.

6. The high melt strength styrene resin composition according to claim 2, wherein the aromatic vinyl monomer is at least one selected from the group consisting of styrene, α-methylstyrene, α-chlorostyrene and p-methylstyrene; the acrylic monomer is one or two selected from the group consisting of acrylonitrile and α-methacrylonitrile.

7. The high melt strength styrene resin composition according to claim 1, wherein the styrene resin is at least one selected from the group consisting of ABS resin, SAN resin, ASA resin and HIPS resin; the styrene alloy is one or two selected from the group consisting of PC/ABS alloy and PC/ASA alloy.

8. The high melt strength styrene resin composition according to claim 1, wherein the antioxidant is a phenolic antioxidant.

9. A method for preparing the high melt strength styrene resin composition according to claim 1, comprising the following steps:
mixing a styrene resin or styrene alloy, a tackifier and a lubricant at 25 to 90° C., and
using a twin screw extruder abrasive machining to extrude pellets at 200 to 260° C. to obtain the high melt strength styrene resin composition.

10. The method according to claim 9, wherein a ratio of length and diameter of the twin screw extruder abrasive machine is more than 34.
